(19) United States
(12) Patent Application Publication
(10) Pub. No.: US 2010/0214253 A1
(43) Pub. Date: Aug. 26, 2010

(54) DRIFT COMPENSATION APPARATUS OF CAPACITIVE TOUCH PANEL AND DRIFT COMPENSATION METHOD THEREOF

(75) Inventors: Tzu-Yi Wu, Kaohsiung County (TW); Lee-Chun Guo, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ITE TECH. INC., Hsinchu (TW)

(21) Appl. No.: 12/430,909

(22) Filed: Apr. 28, 2009

(30) Foreign Application Priority Data
Feb. 25, 2009 (TW) 98106003

(51) Int. Cl. G06F 3/045

(52) U.S. Cl. 345/174

(57) ABSTRACT

A method and an apparatus adapted to a capacitive touch panel for drift compensation are provided, wherein the touch panel includes a plurality of sensors. In the method for drift compensation, a plurality of capacitances respectively sensed by each of the sensors are extracted. Whether the touch panel is in a proximity state is determined upon a slope of the sensed capacitances and a slope parameter. Whether each of the capacitances is drifted is determined upon the capacitance and an allowable noise range. When the touch panel is not in the proximity state and each of the capacitances is drifted, each of the capacitances is compensated according to a drift error of each of the capacitances after a first presetting time has passed.

### CROSS-REFERENCE TO RELATED APPLICATION

This application claims the priority benefit of Taiwan application serial no. 98106003, filed on Feb. 25, 2009. The entirety of the above-mentioned patent application is hereby incorporated by reference herein and made a part of specification.

### BACKGROUND OF THE INVENTION

1. Field of the Invention

The present invention relates to an apparatus and a method for drift compensation, and more particularly to a drift compensation apparatus and a drift compensation method capable of compensating capacitances according to different states of a touch panel.

2. Description of Related Art

With the rapid development of technology, most electronic devices, such as notebook computers, mobile phones or portable multimedia players, usually have touch panels serving as input interfaces of a new generation in replacement of conventional keyboards. The touch panels are generally classified into capacitive, resistive, infrared, and ultrasonic touch panels, wherein the resistive touch panels and the capacitive touch panels are the most common products. The capacitive touch panels are operated by approaching or touching the touch panels with a finger or a conductive material to change capacitances of the touch panels. While variations in the capacitances are detected, the location approached or touched by the finger or the conductive material is determined, and an operation corresponding to the approached or touched location is performed. The capacitive touch panels have a multi-touch feature, which allows a more user-friendly operation mode. Therefore, the capacitive touch panels are gradually favored by the market.

However, due to variations in environmental factors, such as humidity, temperature, coating materials, oil and dust on the touch panels, the capacitances of the touch panels are drifted, so that the touch panels erroneously determining a contact state have reduced sensitivity. Hence, U.S. Pat. No. 5,586,042 (“the '042 patent”) provides an apparatus and a method for measuring and detecting variations in capacitances. According to the '042 patent, the touch panel is determined to be in the contact state while the capacitance sensed by the touch panel is out of a predetermined range. The maximum limit of the predetermined range is a sensor reference value plus a threshold difference amount, and the minimum limit of the predetermined range is the sensor reference value minus the threshold difference amount.

While the sensed capacitance is not equal to the sensor reference value and is within the predetermined range, the capacitance is determined to be drifted. Meanwhile, while the capacitance is between the sensor reference value and the maximum limit of the predetermined range, the sensor reference value is increased. On the other hand, while the capacitance is between the sensor reference value and the minimum limit of the predetermined range, the sensor reference value is decreased. By adjusting the sensor reference value, influence of the capacitance drift posed on determination of the contact state can be reduced. However, the adjusted sensor reference value is a basis for the next determination, and thus it is possible that the apparatus can not timely compensate capacitance drift caused by environmental factors, so that the apparatus can not enhance the sensitivity of the touch panel efficiently.

### SUMMARY OF THE INVENTION

The present invention provides a drift compensation apparatus and a drift compensation of a capacitive touch panel, which are capable of compensating capacitances according to different states of the touch panel during different time periods for enhancing sensitivity of the touch panel.

The present invention provides a drift compensation method adapted to the capacitive touch panel, wherein the touch panel has a plurality of sensors. In the drift compensation method, first, a plurality of capacitances respectively sensed by each of the sensors are extracted. Whether the touch panel is in a proximity state is determined upon a slope of the sensed capacitances and a slope parameter. Whether each of the capacitances is drifted is determined upon each of the capacitances and an allowable noise range. While the touch panel is not in the proximity state and each of the capacitances is drifted, each of the capacitances is compensated according to a drift error of each of the capacitances after a first presetting time has passed.

In an embodiment of the present invention, while the touch panel is in the proximity state, each of the capacitances is compensated according to the drift error of each of the capacitances after a second presetting time has passed.

In an embodiment of the present invention, while the touch panel is in the proximity state, the state of the touch panel is recorded to execute a post-process after the second presetting time has passed.

In an embodiment of the present invention, the drift compensation method further includes determining whether the touch panel is in a contact state according to each of the capacitances and a contact threshold while the touch panel is in the proximity state and resetting the second presetting time while the touch panel is in the contact state.

The present invention further provides a drift compensation apparatus adapted to a capacitive touch panel, wherein the touch panel has a plurality of sensors, and each of the sensors respectively senses a plurality of capacitances according to a scan period. The drift compensation apparatus includes a proximity detector, a drift detector, a counting unit and a capacitance compensation unit. The proximity detector is coupled to the touch panel for determining whether the touch panel is in a proximity state according to a slope of the sensed capacitances and a slope parameter, so as to generate a first control signal. The drift detector is coupled to the touch panel for determining whether each of the capacitances is drifted according to each of the capacitances and an allowable noise range, so as to generate a second control signal. The counting unit is coupled to the proximity detector and the drift detector. While the touch panel is not in the proximity state and each of the capacitances is drifted, the counting unit is controlled by the first control signal and the second control signal, so as to execute a count of a first presetting time. The capacitance compensation unit is coupled to the counting unit for compensating each of the capacitances according to a drift error of each of the capacitances after the first presetting time has passed.

In an embodiment of the present invention, while the touch panel is in the proximity state, the counting unit is controlled by the first control signal, so as to execute a count of a second presetting time. The capacitance compensation unit compensates each of the capacitances according to the drift error of each of the capacitances after the second presetting time has passed. Wherein, the second presetting time is longer than the first presetting time.

In an embodiment of the present invention, while the touch panel is in the proximity state, the counting unit is controlled by the first control signal, so as to execute a count of a second presetting time. The proximity detector records the state of the touch panel to execute a post-process after the second presetting time has passed.

In an embodiment of the present invention, the drift compensation apparatus further includes a contact detector coupled to the counting unit. The contact detector determines whether the touch panel is in a contact state according to each of the capacitances and a contact threshold, so as to generate a third control signal. While the touch panel is in the contact state, the counting unit is controlled by the third control signal, so as to reset the count of the second presetting time.

To sum up, in the drift compensation apparatus and the drift compensation method of the capacitive touch panel according to the present invention, the slope of the sensed capacitances and the slope parameter are compared to determine whether the touch panel is in the proximity state. While the touch panel is in the proximity state, the counting unit executes the count of the second presetting time, so that the capacitance compensation unit determines and compensates the capacitance drift after the counting unit finishes the count. While the touch panel is not in the proximity state, the counting unit executes the count of the first presetting time, so that the capacitance compensation unit compensates the capacitances after the counting unit finishes the count. Therefore, according to the contact state of the touch panel, the capacitance compensation unit executes drift compensation to prevent the sensitivity of the touch panel from being affected by the capacitance drift arisen from environmental factors. Besides, the setting related to the second presetting time also makes the proximity detector record the state of the touch panel, so as to facilitate implementation of the post-process.

In order to make the features of the present invention comprehensible, exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments consistent with the present invention, and together with the description, serve to explain the principles of the invention.

FIG. 1 is a graph illustrating capacitances sensed by the sensors and varied with time.

FIG. 2A is a schematic diagram of a drift compensation apparatus according to one embodiment of the present invention.

FIG. 2B is a graph of the compensated capacitances corresponding to the drift compensation apparatus of FIG. 2A according to one embodiment of the present invention.

FIG. 3 is a flowchart of a drift compensation method according to one exemplary embodiment consistent with the present invention.

FIG. 4 is a flowchart of a drift compensation method according to another exemplary embodiment consistent with the present invention.

### DESCRIPTION OF EMBODIMENTS

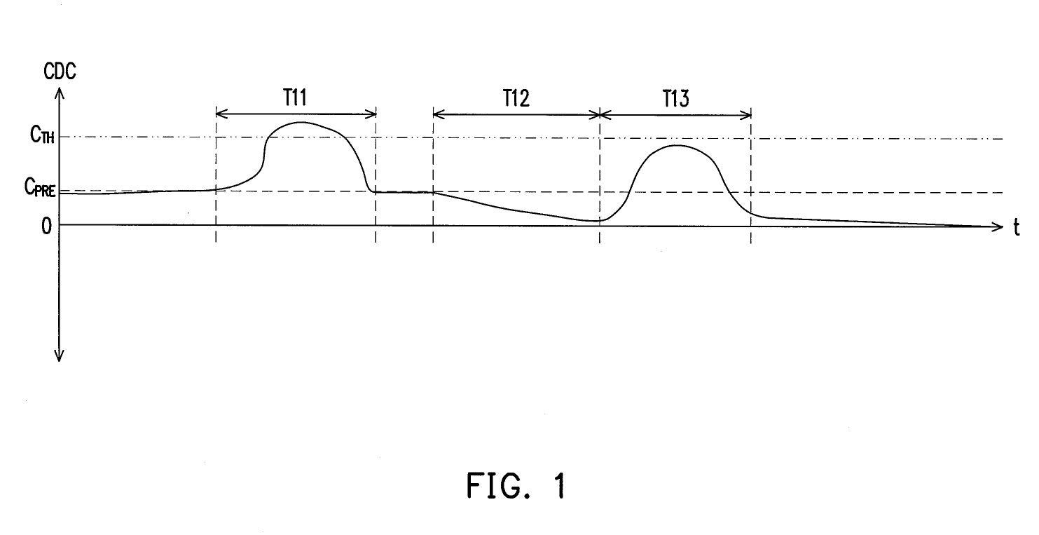

Capacitive touch panels usually have a plurality of sensors for sensing capacitances, and each of the sensor senses the capacitances according to a scan period. While a touch object contacts with the touch panel, capacitance coupling is generated, and the capacitances sensed by the sensors are varied. However, the capacitances sensed by the sensors are drifted due to the environmental factors, such as humidity, temperature, coating materials, oil and dust on the touch panel. FIG. 1 is a graph illustrating capacitances sensed by the sensors and varied with time. Referring to FIG. 1, when the sensors are untouched, a capacitance CDC sensed by the sensors constantly refers to a predetermined capacitance C_{PRE}. During a period T11, the touch panel is touched, so that the capacitances CDC sensed by the sensors have specific variations. Meanwhile, by comparing the capacitance CDC with a contact threshold C_{TH}, whether the touch panel is in a contact state is determined.

Next, during a period T12, the capacitance CDC sensed by the sensors is drifted due to the environmental factors and is then decreased slowly. During a period T13, although the touch panel is touched again and the capacitances CDC sensed by the sensors have specific variations, the drift due to the environmental factors results in the fact that the capacitance CDC can not arrive at the contact threshold C_{TH}, and therefore the sensors erroneously determine that the touch panel is not in the contact state. Meanwhile, the touch panel does not further detect the contact location, so that the touch panel fails to operate. Accordingly, in the embodiment, the drift of the capacitance CDC is compensated by a drift compensation apparatus capable of making the touch panel work normally and enhancing sensitivity of the touch panel.

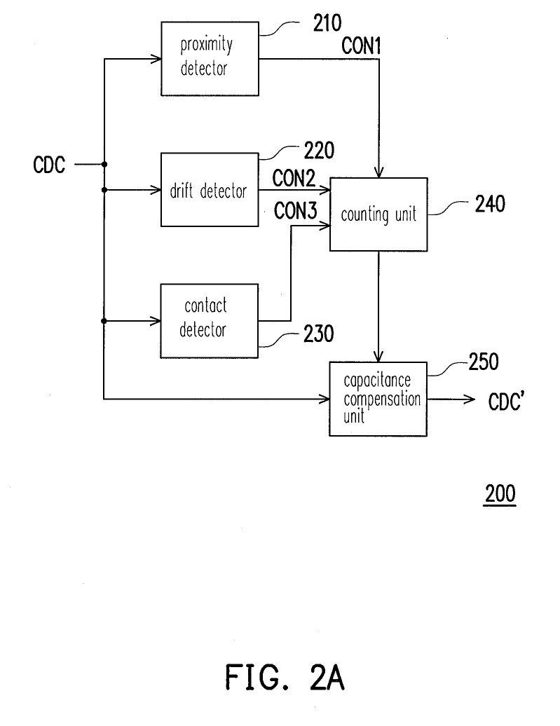

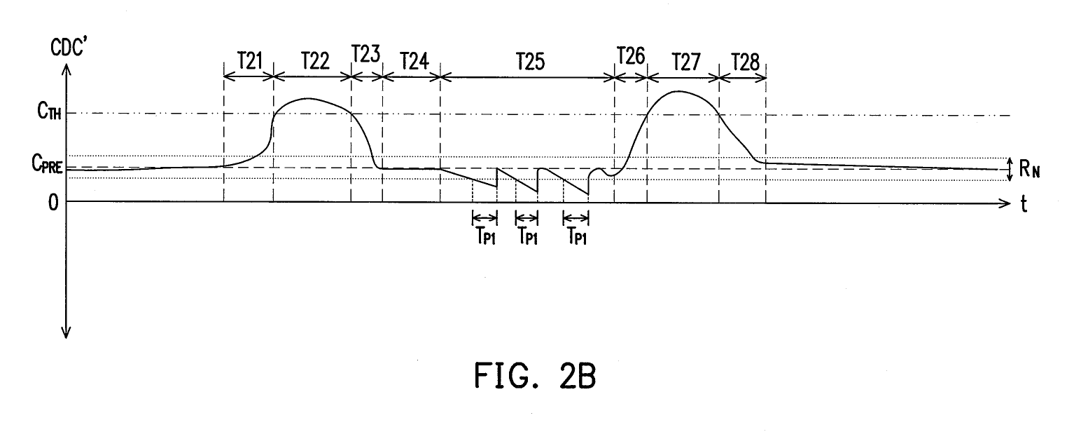

FIG. 2A is a schematic diagram of a drift compensation apparatus according to one embodiment of the present invention. Referring to FIG. 2A, the drift compensation apparatus 200 includes a proximity detector 210, a drift detector 220, a contact detector 230, a counting unit 240, and a capacitance compensation unit 250. The proximity detector 210 is coupled to the touch panel and receives the capacitance CDC sensed by the sensors of the touch panel. When a touch object (e.g. a finger or a capacitive pan) approaches to or contacts with the touch panel, the capacitances sensed by the sensors have specific variations. Thus, according to a slope of the sensed capacitances and a slope parameter, the proximity detector 210 determines what state the touch panel is in; for example, the touch object can approach to, contact with, or leave the touch panel, or when the touch panel can be untouched as normal, so as to generate a control signal CON1 to control the counting unit 240. While the slope of the sensed capacitance CDC is larger than the slope parameter, the proximity detector 210 determines that the touch panel is in the proximity state. On the contrary, when the slope of the sensed capacitance CDC is smaller than the slope parameter, the proximity detector 210 determines that the touch panel is not in the proximity state.

During the operation of the circuit, unavoidable noises result in minor variations in the capacitances sensed by the sensors. Compared with the drift of the capacitance CDC due to the environmental factors, the noises less affects the determination of the contact state. Accordingly, in order to distinguish the variations in the capacitances caused by the noises from the drift of the capacitances due to the environmental factors, the drift detector 220 is coupled to the touch panel for determining whether the capacitance CDC is drifted according to a result of comparing the capacitance CDC with an allowable noise range, so as to generate a control signal CON2 to control the counting unit 240. While the capacitance CDC is within the allowable noise range, the drift detector 220 determines that the capacitance is not drifted, and otherwise, the drift detector 220 determines the capacitance is drifted.

The contact detector 230 is coupled to the touch panel. While the proximity detector 210 determines that the touch panel is in the proximity state, the contact detector 230 further determines whether the touch panel is in a contact state according to the capacitance CDC and a contact threshold C_{TH}, so as to generate a control signal CON3 to control the counting unit 240. While the capacitance CDC is larger than the contact threshold C_{TH}, the contact detector 230 determines that the touch panel is in the contact state, and otherwise, the contact detector 230 determines that the touch panel is not in the contact state.

The counting unit 240 is coupled to the proximity detector 210, the drift detector 220 and the contact detector 230. While the touch panel is not in the proximity state and the capacitance is drifted, the counting unit 240 is controlled by the control signals CON1 and CON2, so as to execute a count of a first presetting time. When the count of the first presetting time has been finished, the counting unit 240 controls the capacitance compensation unit 250 to compensate the drift of the capacitance CDC. Besides, while the touch panel is in the proximity state, the counting unit 240 is controlled by the control signal CON1, so as to execute a count of a second presetting time. When the count of the second presetting time has been finished, the counting unit 240 controls the capacitance compensation unit 250 to compensate the drift of the capacitance CDC. Herein, the control signals CON1 and CON2 are processed by a logic unit (not shown) which controls the counting unit 240 to execute the count of the first presetting time or the second presetting time. The capacitance compensation unit 250 is coupled to the counting unit 240 for compensating the capacitance CDC according to a drift error of the capacitance CDC, so as to output the compensated capacitance CDC′.

While the capacitance CDC is drifted, the counting unit 240 executes a count of a shorter time (for example, the first presetting time is 5 seconds) to prevent the capacitance CDC from being excessively drifted, which affects accuracy of determining the contact state. In addition, while the touch panel is in the proximity state or in the contact state, the capacitance sensed by the sensors has specific variations, and thus if the capacitance compensation unit 250 compensates the capacitance CDC while users operate the touch panel, exact drift of the capacitance CDC cannot be obtained by the capacitance compensation unit 250, so that an error occurs in drift compensation. Accordingly, while the touch panel is in the proximity state, the counting unit 240 executes a count of a longer time (for example, the second presetting time is 10 seconds), and while the touch panel is switched from the proximity state to the contact state, the counting unit 240 is controlled by the control signal CON3, so as to reset the count of the second presetting time to prevent the erroneous drift compensation. Herein, the present embodiment takes the second presetting time longer than the first presetting time as an example, but the scope of the present invention is not limited thereby, and those skilled in the art can still modify the presetting time in accordance with practical design requirements as desired. For example, the second presetting time can be determined according to the statistical time of the touch panel switching from the proximity state to the contact state. That is, when the count of the second presetting time has been finished, and the touch panel is not switched from the proximity state to the contact state, it means that an error occurs in determining the proximity state due to the excessive drift, and thus the capacitance compensation unit 250 should timely compensate the capacitance drift.

FIG. 2B is a graph of the compensated capacitances corresponding to the drift compensation apparatus of FIG. 2A according to one embodiment of the present invention. Referring to FIGS. 2A and 2B, before a period T21 (or during a period T24), since the touch panel is untouched, the capacitance CDC sensed by the sensors substantially refers to the predetermined capacitance C_{PRE} constantly, wherein noises may cause minor variations in the capacitance CDC within an allowable noise range R_{N}, so that the capacitance CDC is not equal to the predetermined capacitance C_{PRE}. Meanwhile, the slope of the capacitance CDC is smaller than the predetermined slope parameter (e.g. 0.6), and thus the proximity detector 210 determines the touch panel is in the normal state. Additionally, the capacitance CDC is not out of the allowable noise range R_{N}, so that the capacitance compensation unit 250 does not have to compensate the capacitance CDC.

During the period T21, since the touch object approaches to the touch panel, the capacitance CDC sensed by the sensors has specific variations. Meanwhile, the slope of the capacitance CDC is larger than or equal to the slope parameter, and the proximity detector 210 determines the touch panel is in the proximity state, so as to generate the control signal CON1 to drive the counting unit 240 to execute the count of the second presetting time. Generally, since the time during which the touch object approaches the touch panel and contacts the same is short, the capacitance CDC is usually larger than the contact threshold C_{TH} before the count of the second presetting time has been finished as shown in a period T22, so that the proximity detector 210 determines the touch panel is in the contact state. While the touch panel is in the contact state, since the variations in the capacitance CDC are caused by the contact, the capacitance compensation unit 250 does not have to compensate the capacitance CDC, so that the counting unit 240 resets the count of the second presetting time to prevent the erroneous compensation. Otherwise, when the count of the second presetting time has been finished and the touch panel still does not switch from the proximity state to the contact state, it means that an error occurs in determining the proximity state due to the drift of the capacitance CDC, and thus the capacitance compensation unit 250 should compensate the capacitance drift.

During a period T23, since the touch object leaves the touch panel, the capacitance CDC sensed by the sensors decreases. Meanwhile, the slope of the capacitance CDC is negative, and the proximity detector 210 determines the touch panel is not in the proximity state but in a leaving state. Since it is possible that the capacitance in the leaving state abruptly decreases due to the drift, if the capacitance compensation unit 250 does not compensate the capacitance CDC as soon as possible, the contact detector 230 is likely to mistakenly determine that the touch panel is not in the contact state in the next contact. Accordingly, while the touch panel is not in the proximity state, and the capacitance CDC is out of the allowable noise range R_{N} and is deemed drifted, the drift detector 220 controls the counting unit 240 to execute the count of the first presetting time, and thus when the count of the first presetting time has been finished, the capacitance compensation unit 250 compensates the capacitance CDC. In the present embodiment, the capacitance compensation unit 250 compensates the capacitance CDC according to a difference between the capacitance CDC and the predetermined capacitance C_{PRE} (i.e., a drift error). When the period T23 is terminated, the capacitance CDC returns approximately back to the predetermined capacitance C_{PRE}. Thus, the effect of the compensation shown in FIG. 2B is not apparent because the drift error approaches to zero.

During a period T25, the capacitance of the touch panel is drifted due to the environmental factors; for example, users carrying the touch panel may walk from the indoors to the outdoors, or water, oil or dust may adhere to the touch panel. Meanwhile, while the capacitance CDC is out of the allowable noise range R_{N} and is deemed drifted, the drift detector 220 controls the counting unit 240 to execute the count of the first presetting time T_{P1}. When the count of the first presetting time T_{P1} has been finished, the counting unit 240 controls the capacitance compensation unit 250 to compensate the capacitance CDC. The capacitance compensation unit 250 compensates the capacitance CDC according to the difference between the capacitance CDC and the predetermined capacitance C_{PRE} (i.e., a drift error), so that the compensated capacitance CDC returns approximately back to the predetermined capacitance C_{PRE}.

During a period T26, since the touch object approaches to or contacts with the touch panel again, the capacitance CDC sensed by the sensors has specific variations. Using the capacitance compensation unit 250 to timely compensate the capacitance CDC can enhance the accuracy of determining the states of the touch panel and improve the sensitivity of the touch panel. In addition, the compensated capacitance is provided for conducting a positioning operation of the contact location and enhancing the positioning accuracy. Note that the above-mentioned predetermined capacitance has a constant value within the allowable noise range R_{N} (including the maximum limit and the minimum limit of the allowable noise range R_{N}). The contact threshold C_{TH}, the predetermined capacitance C_{PRE} and the allowable noise range R_{N} are different according to the structure and materials of the touch panel, and thus the present invention is not limited herein. Besides, in another embodiment of the present invention, the contact detector 230 can be integrated into the proximity detector 210 for determining whether the touch panel is in the proximity state or in the contact state.

Note that the touch panel switches to be in different states with different time periods due to different operations. In other embodiments of the present invention, when the count of the second presetting time has been finished, the drift compensation apparatus records the current state of the touch panel, such as the proximity state, the contact state, the leaving state or the untouched normal state, to execute a post-process, such as the positing operation of the contact location or a related hardware control process, through the proximity detector 210, in addition to compensating the drift through the capacitance compensation unit 250. Referring to FIG. 2A, in other embodiments of the present invention, while the counting unit 240 is controlled by the control signal CON1 to execute the count of the second presetting time, the proximity detector 210 records the state of the touch panel when the count of the second presetting time has been finished. Before the count of the second presetting time has been finished, the contact detector 230 still determines whether the touch panel switches from the proximity state to the contact state. Herein, the setting of the second presetting time is used as a reference to record the state of the touch panel. Therefore, while the touch panel is determined to be in the contact state, the second presetting time does not have to be reset.

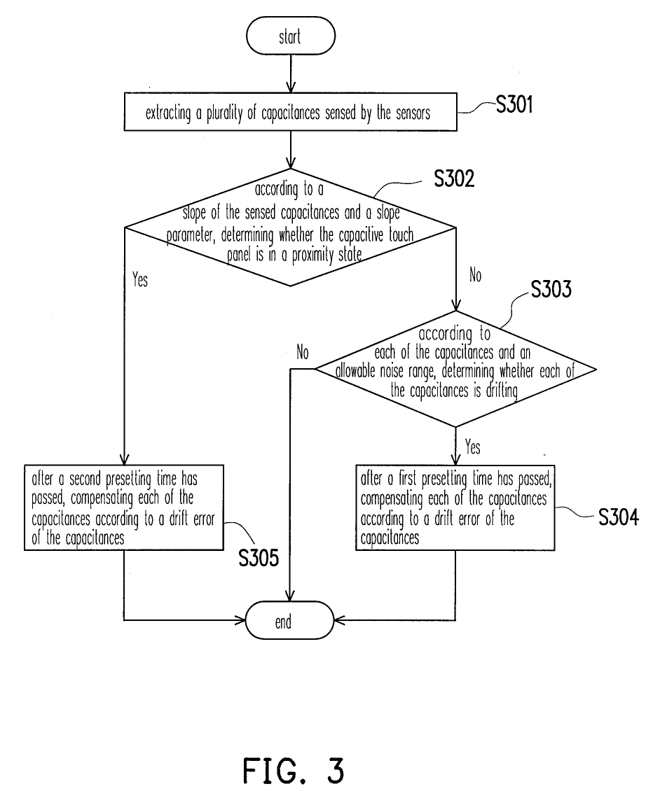

The above-mentioned embodiments can be summarized as follows. FIG. 3 is a flowchart of a drift compensation method according to one exemplary embodiment consistent with the present invention. Referring to FIG. 3, first, a plurality of capacitances sensed by the sensors are extracted (step S301). Next, according to a compared result between a slope of the capacitances and a slope parameter, it is determined whether the touch panel is in a proximity state (step S302). While the slope of the capacitances is smaller than the slope parameter, it is determined that the touch panel is not in the proximity state, and further, according to a compared result of the capacitances and an allowable noise range, it is determined whether the capacitances are drifted (step S303). While the capacitances are out of the allowable noise range, it is determined that the capacitances are drifted, and after a first presetting time has passed, the capacitances are compensated according to a drift error (step S304). On the contrary, while the capacitances are in the allowable noise range, it is determined that the capacitances are not drifted, so that the capacitances do not have to be compensated.

On the other hand, while the slope of the capacitances is larger than or equal to the slope parameter, it is determined that the touch panel is in the proximity state, and after a second presetting time has passed, the capacitances are compensated according to the drift error (step S305). Accordingly, by setting the second presetting time, erroneous drift compensation caused by variations in the capacitances which are induced by a touch object approaching to or contacting with the touch panel is prevented. Besides, it can be prevented that compensation of the capacitances is likely to be neglected when the proximity detector 210 mistakenly determines that the touch panel is in the proximity state due to the drift of the capacitances. In other embodiments of the present invention, when the count of the second presetting time has been finished, the drift compensation apparatus is not limited to compensate the capacitance drift through the capacitance compensation unit 250. The drift compensation apparatus can also record the state of the touch panel to execute the post-process through the proximity detector 210.

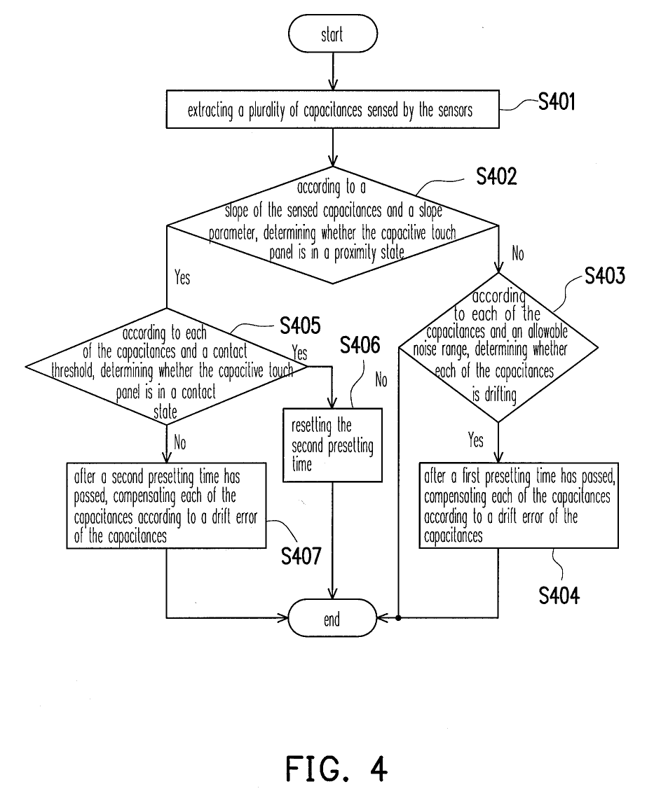

FIG. 4 is a flowchart of a drift compensation method according to another exemplary embodiment consistent with the present invention. Referring to FIGS. 3 and 4, the difference between the exemplary embodiment of FIG. 4 and the exemplary embodiment of FIG. 3 lies in that while the touch panel is in the proximity state, according to a compared result of the capacitances and the contact threshold C_{TH}, it is further determined whether the touch panel is in a contact state (step S405). While the capacitances are larger than or equal to the contact threshold C_{TH}, it is determined that the touch panel is in the contact state, and the second presetting time is reset (step S406) in order to prevent an erroneous drift compensation caused by variations in the capacitances which are induced by a touch object approaching to or contacting with the touch panel. On the contrary, while the capacitances are smaller than the contact threshold C_{TH}, it is determined that the touch panel is not in the contact state, and therefore, after a second presetting time passed, the capacitances are compensated according to the drift error (step S407). In other embodiments of the present invention, when the count of the second presetting time has been finished, the drift compensation apparatus is not limited to compensate the capacitance drift through the capacitance compensation unit 250. The drift compensation apparatus can also record the state of the touch panel to execute the post-process through the proximity detector 210. Accordingly, while the touch panel is in the contact state, the step S406 of resetting the second presetting time is not necessary. Meanwhile, the positing operation of the contact location, for example, can be executed.

To sum up, the above-mentioned embodiments determine the states of the touch panel according to the slope of the capacitances and the slope parameter. While the touch panel is in the proximity state, the count of the second presetting time is executed, and when the count has been finished, the capacitances are determined, and the capacitance drift is compensated. While the touch panel is in the normal state and the capacitance is drifted, the count of the first presetting time is executed, and when the count has been finished, the capacitances are compensated. Therefore, the capacitances are timely compensated, so that the sensitivity of the touch panel and the accuracy of the post-process, such as the positioning operation of the contact location, are enhanced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A drift compensation method of a capacitive touch panel, wherein the capacitive touch panel has a plurality of sensors and comprises:
extracting a plurality of capacitances respectively sensed by each of the sensors;
determining whether the capacitive touch panel is in a proximity state according to a slope of the sensed capacitances and a slope parameter;
determining whether each of the capacitances is drifted according to each of the capacitances and an allowable noise range; and
compensating each of the capacitances according to a drift error of each of the capacitances after a first presetting time when the capacitive touch panel is not in the proximity state and each of the capacitances is drifted.

2. The drift compensation method as claimed in claim 1, further comprising:
compensating each of the capacitances according to the drift error of each of the capacitances after a second presetting time when the capacitive touch panel is in the proximity state.

3. The drift compensation method as claimed in claim 2, wherein the second presetting time is longer than the first presetting time.

4. The drift compensation method as claimed in claim 2, further comprising:
when the capacitive touch panel is in the proximity state, determining whether the capacitive touch panel is in a contact state according to each of the capacitances and a contact threshold; and
when the capacitive touch panel is in the contact state, resetting the second presetting time.

5. The drift compensation method as claimed in claim 1, wherein the step of determining whether the capacitive touch panel is in the proximity state according to the slope of the sensed capacitances and the slope parameter comprises:
when the slope of the sensed capacitances is smaller than the slope parameter, determining the capacitive touch panel is not in the proximity state; and
when the slope of the sensed capacitances is larger than the slope parameter, determining the capacitive touch panel is in the proximity state.

6. The drift compensation method as claimed in claim 1, wherein the step of determining whether each of the capacitances is drifted according to each of the capacitances and the allowable noise range comprises:
when each of the capacitances is out of the allowable noise range, determining each of the capacitances is drifted; and
when each of the capacitances is within the allowable noise range, determining each of the capacitances is not drifted.

7. The drift compensation method as claimed in claim 1, wherein the drift error is an offset between each of the capacitances and a predetermined capacitance.

8. The drift compensation method as claimed in claim 1, further comprising:
when the capacitive touch panel is in the proximity state, recording the state of the capacitive touch panel to execute a post-process after the second presetting time has passed.

9. The drift compensation method as claimed in claim 8, further comprising:
when the capacitive touch panel is in the proximity state, determining whether the capacitive touch panel is in a contact state according to each of the capacitances and a contact threshold.

10. A drift compensation apparatus of a capacitive touch panel, wherein the capacitive touch panel has a plurality of sensors, and each of the sensors respectively senses a plurality of capacitances according to a scan period, the drift compensation apparatus comprising:
a proximity detector, coupled to the capacitive touch panel and determining whether the capacitive touch panel is in a proximity state according to a slope of the sensed capacitances and a slope parameter, so as to generate a first control signal;
a drift detector coupled to the capacitive touch panel and determining whether each of the capacitances is drifted according to each of the capacitances and an allowable noise range, so as to generate a second control signal;
a counting unit coupled to the proximity detector and the drift detector, wherein when the capacitive touch panel is not in the proximity state and each of the capacitances is drifted, the counting unit is controlled by the first control signal and the second control signal, so as to execute a count of a first presetting time; and
a capacitance compensation unit coupled to the counting unit and compensating each of the capacitances according to a drift error of each of the capacitances after the first presetting time has passed.

11. The drift compensation apparatus as claimed in claim 10, wherein when the capacitive touch panel is in the proximity state, the counting unit is controlled by the first control signal and executes a count of a second presetting time, and the capacitance compensation unit compensates each of the capacitances according to the drift error of each of the capacitances after the second presetting time has passed.

12. The drift compensation apparatus as claimed in claim 11, wherein the second presetting time is longer than the first presetting time.

13. The drift compensation apparatus as claimed in claim 11, further comprising:
a contact detector coupled to the counting unit and determining whether the capacitive touch panel is in a contact state according to each of the capacitances and a contact threshold, so as to generate a third control signal, wherein when the capacitive touch panel is in the contact state, the counting unit is controlled by the third control signal and resets the count of the second presetting time.

14. The drift compensation apparatus as claimed in claim 10, wherein when the slope of the sensed capacitances is smaller than the slope parameter, the proximity detector determines that the capacitive touch panel is not in the proximity state, and when the slope of the sensed capacitances is larger than the slope parameter, the proximity detector determines that the capacitive touch panel is in the proximity state.

15. The drift compensation apparatus as claimed in claim 10, wherein when each of the capacitances is out of the allowable noise range, the drift detector determines that each of the capacitances is drifted, and when each of the capacitances is within the allowable noise range, the drift detector determines that each of the capacitances is not drifted.

16. The drift compensation apparatus as claimed in claim 10, wherein the drift error is an offset between each of the capacitances and a predetermined capacitance.

17. The drift compensation apparatus as claimed in claim 10, wherein when the capacitive touch panel is in the proximity state, the counting unit is controlled by the first control signal and executes a count of a second presetting time, and the proximity detector records the state of the capacitive touch panel to execute a post-process after the second presetting time has passed.

18. The drift compensation apparatus as claimed in claim 17, further comprising:
a contact detector coupled to the counting unit and determining whether the capacitive touch panel is in a contact state according to each of the capacitances and a contact threshold.
